(19) United States
(12) Patent Application Publication
(10) Pub. No.: US 2010/0202602 A1
(43) Pub. Date: Aug. 12, 2010

(54) Establishing a Call From a Calling Party to a Destination in a Telecommunications Network Using a Pre-Answer Service Without Charging

(76) Inventors: Rogier Noldus, BM Goirle (NL); Daniel Akkermans, PK Oosterhout (NL)

Correspondence Address: COATS & BENNETT, PLLC, 1400 Crescent Green, Suite 300, Cary, NC, 27518, US

(21) Appl. No.: 12/667,805

(22) PCT Filed: Jul. 6, 2007
(86) PCT No.: PCT/EP2007/006009

§ 371 Date: Jan. 19, 2010

(51) Int. Cl. H04M 3/42

(52) U.S. Cl. 379/201.01

(57) ABSTRACT

Method for establishing a call from a calling party to a destination using a pre-answer service in a telecommunication network, whereby the telecommunication network may comprise a first switching node and a second switching node, the first and second switching nodes communicatively connected, the calling party communicatively connected to the first switching node, the destination communicatively connected to the second switching node. The method further comprising the steps of setting up a call between the calling party and the second switching node, invoking an IN service associated with the pre-answer service, connecting the call to the pre-answer service, charging an account of the calling party by the first switching node upon receiving a connection confirmation message relating to the call, completing the pre-answer service, disconnecting the call from the pre-answer service upon completion of the pre-answer service, connecting the call to the destination, sending a pre-answer instruction to the second switching node upon invoking the IN service, whereby the step of connecting the call to the pre-answer service is performed upon receipt of the pre-answer instruction, sending an establish pre-answer speech path instruction to the first switching node upon connection confirmation from the pre-answer service and sending a connection confirmation message to the calling party by the first switching node upon receipt of the establish pre-answer speech path instruction, whereby the step of charging the account of the calling party is performed upon completing the step of connecting the call to the destination.

### TECHNICAL FIELD

The invention relates to a method for establishing a call from a calling party to a called party using a pre-answer service in a telecommunication network, an IN service associated with the pre-answer service, a switching node serving the calling party and a switching node invoking the IN service.

### BACKGROUND

Some Intelligent Network (IN) services apply a method of connecting a calling party to an Interactive Voice Response (IVR) system, thereby providing a pre-answer service prior to establishing a call to a destination, i.e. a called party. The connection to the IVR may be used to enable the calling party to enter digits on his terminal in order to make a choice in the menu. When the calling party has made his choice, call connection may continue. The call may now be established to the requested destination. An example of such a pre-answer service is Carrier Selection. The calling party is prompted to make a choice after dialling a destination number by pressing a key or by entering a digit or digit combination on the terminal.

An IN service invoked for the call, providing a prompt to the calling party, instructs for example a serving Mobile Switching Centre (MSC), also referred to as Visited Mobile Switching Centre (VMSC-A), to connect the calling party to the pre-answer service, for example the IVR, and since the IN service has control over the call, the MSC may be instructed by the IN service to perform the service without charging the calling party for the pre-answer service.

Normally a serving MSC starts charging a calling party's account when a connection confirmation from the destination or from the pre-answer service is received by the serving MSC. The MSC may now be instructed by the IN service to connect the speech path in forward direction from the calling party to the IVR upon receipt of a connection confirmation from the IVR, but defer charging until the call is disconnected from the IVR and connected to the destination and a connection confirmation from the destination is received.

Thus the above described method facilitates that the calling party is not charged for the pre-answer service. However, this can only be performed in connection with an IN service invoked from the serving MSC of the calling party, since only such an IN service has control over the MSC.

If however, as described above, the IN service is invoked from an MSC other than the serving MSC to which the calling subscriber is connected, e.g. invoked via a Transit MSC or a Gateway Mobile Switching Centre (GMSC), then the IN service does not have the option to instruct the MSC to defer the start of charging until the calling party is connected to the destination of the call and this destination has answered the call. In such case, the charging of the call will always start as soon as the connection of the call to the pre-answer service is completed, i.e. a connection confirmation message is received.

Alternatively, the IN service may instruct the MSC not to signal the connection to the pre-answer service in backwards direction, in which case the calling party will not be charged for the connection to the pre-answer service. However, in that case no interaction will be possible between the calling party and the pre-answer service, resulting in that the calling party will not be able to take advantage of the pre-answer service, i.e. indicate a choice to the pre-answer service, since only a backward unidirectional speech path is established and a forward speech path is required for interaction between the calling party and the pre-answer service.

### SUMMARY

It is therefore an object of the present invention to enable a calling party to use a pre-answer service, without being charged until a final connection to a destination is established, even if the serving switching node from where charging of calling party's account is performed, e.g. VMSC-A, is not the same switching node from where the IN service associated with the pre-answer service is invoked, e.g. GMSC.

The object of the invention is achieved according to a first aspect of the invention in a method according to claim 1.

The method of claim 1 is a method for establishing a call from a calling party to a destination using a pre-answer service in a telecommunication network, whereby the telecommunication network may comprise a first switching node and a second switching node, the first and second switching nodes communicatively connected, the calling party communicatively connected to the first switching node, the destination communicatively connected to the second switching node. The first switching node acts as a serving switching node for the calling party. The second switching node acts a switching node for providing the pre-answer service as described below.

The method may comprise the steps of setting up a call to the destination between the calling party and the second switching node, invoking by the second switching node an IN service associated with the pre-answer service, sending a pre-answer instruction by the IN service to the second switching node, connecting the call to the pre-answer service by the second switching node upon receipt of the pre-answer instruction, sending an establish pre-answer speech path instruction to the first switching node upon connection confirmation from the pre-answer service and sending a connection confirmation message to the calling party by the first switching node upon receipt of the establish pre-answer speech path instruction.

Now interaction between calling party and the pre-answer service may take place. The method continues by completing the pre-answer service by either the pre-answer service or by the calling party, disconnecting the call from the pre-answer service upon completion of the pre-answer service and connecting the call to the destination.

Now the call is connected to the destination.

The first switching node is arranged for charging an account of the calling party by the first switching node upon receiving a connection confirmation message relating to the call, thus first switching node will start charging the account of the calling party upon completing the step of connecting the call to the destination. Call connection completion is in general accomplished by sending a connection completion message by a connected party (destination, pre-answer service) to the calling party.

By sending the first pre-answer instruction from the intelligent network service to the second switching node, the second switching node is brought in a state where it waits for a connection confirmation message from the pre-answer service.

When this message arrives the second switching node sends the second pre-answer instruction to the visited mobile switching centre instead of a normal connection confirmation message, thereby enabling the visited mobile switching centre to complete the call to the calling party without charging the calling party's account.

This way a connection from the calling party to the pre-answer service is established, at the same time preventing the first switching node from charging the calling party's account until the call to the pre-answer service is disconnected and re-connected to the destination. The charging of the calling party's account starts upon completion of the call to the destination. Thus a pre-answer service is established without charging the calling party.

In an embodiment according to the first aspect of the invention, the step of completing the connection to the destination comprises sending a call progress indication message by the first switching node to the calling party upon completing the step of connecting the call to the destination.

This embodiment provides signaling to the calling party where the connection is already complete, preventing that first switching node's response is void upon receipt of the connection confirmation message from the destination.

A further embodiment according the first aspect of the invention, further comprises establishing the presence of the calling party in a home public land mobile network or home public switched telephone network, and sending a call completion message upon completion of the connection to the pre-answer service if calling party is not in the Home public land mobile network or Public Switched Telephone Network (PSTN).

This embodiment provides the advantage that the usage of the pre-answer service without charging can be limited to connection through the home telecommunication network. This embodiment can be used by operators who will not provide pre-answer services from other networks free of charge.

The object is also achieved in a second aspect of the invention, in IN service means for use in the steps of the above described method, the IN service means connected to a first switching node, wherein the IN service can be invoked from the first switching node upon interception of a call by the first switching node, wherein the IN service means is arranged for sending a pre-answer instruction to the second switching node, the pre-answer instruction causing the second switching node connect the call to a pre-answer service means, the pre-answer instruction further causing the first switching node to send an establish pre-answer speech path instruction to a second switching node upon connection confirmation to the pre-answer service, disconnecting the call from the pre-answer service upon completion of the pre-answer service by the pre-answer service means, connecting the call to the destination.

The object is also achieved in a third aspect according to the invention, in a switching node for serving a calling party, for use in the steps of the above described method, wherein the switching node is communicatively connected to a second switching node and a calling party, the switching node arranged for charging an account of the calling party for a call from the calling party to a destination upon receipt of a connection confirmation message relating to the call, characterized in that the switching node is arranged for sending a connection confirmation message to the calling party upon receipt of an establish pre-answer speech path instruction from the second switching node.

In an embodiment according to the third aspect of the invention, the switching node may be further arranged for sending a call progress indication message to the calling party upon receipt of the connection confirmation message relating to the call.

In a further embodiment according to the third aspect of the invention the establish pre-answer speech path instruction comprises an ISUP Call Progress (CPG) message or an ISUP Facility (FAC) message with an argument indicating the switching node to send a connection confirmation message to the calling party.

In yet a further embodiment according to the third aspect of the invention, the call progress indication message to the calling party comprises a DTAP Progress message or a DSS1 Progress message.

The object is also achieved in a fourth aspect according to the invention in a switching node for providing a pre-answer service, for use in the steps of the method as described above, the switching node communicatively connected to IN service means, a further switching node, pre-answer service means and a destination. The switching node is arranged for invoking the IN service means and connecting a call from the further switching node to the pre-answer service means and connecting a call from the further switching node to the destination. The switching node is further arranged for: receiving a pre-answer instruction from the invoked IN service means, connecting the call to the pre-answer service means upon receipt of the pre-answer instruction, and sending an establish pre-answer speech path instruction to the further switching node upon receiving connection confirmation from the pre-answer service.

In an embodiment according to the second or fourth aspect of the invention, the pre-answer instruction may be an adapted INAP/CAP Connect To Resource (CTR) or an adapted INAP/CAP Establish Temporary Connection (ETC) operation.

In a further embodiment according to the second or fourth aspect of the invention, the INAP/CAP Connect To Resource (CTR) or Establish Temporary Connection (ETC) operation comprises a Bothway Through Connection Indicator (BTCI) having a value “bothwayPathPreAnswerRequired”.

The object is also achieved in a fifth aspect according to the invention, in a telecommunication network comprising a calling party, a first switching node, a second switching node, an IN service means, a pre-answer service, a destination, arranged for performing the steps of the method as described above.

### BRIEF DESCRIPTION OF THE DRAWINGS

FIG. 1 shows schematically an architecture of a pre-answer service in a telecommunication network using a mobile switching centre of a calling party according to the state of the art.

FIG. 2 shows schematically an architecture of a pre-answer service in a telecommunication network using a visited mobile switching centre of a calling party and a gateway mobile switching centre of a destination according to the state of the art.

FIG. 3 shows schematically an architecture of a pre-answer service in a telecommunication network using a visited mobile switching centre of a calling party and a gateway mobile switching centre of a destination according to the invention.

FIG. 4 shows schematically an architecture of a pre-answer service in a telecommunication network using a visited mobile switching centre of a calling party and a gateway mobile switching centre of a destination according to a further embodiment of the invention.

FIG. 5 shows schematically an architecture of a pre-answer service in a fixed telecommunication network, according to an embodiment of the invention.

FIG. 6 shows a sequence diagram relating to the architecture of FIG. 3, 4 or 5, according to the invention.

### DETAILED DESCRIPTION

In the following detailed description and attached drawings, corresponding features will be referenced to by the same reference number. Calling party, referred to in the text, is synonym for a terminal or telephone of a subscriber. The terminal or telephone may be fixed or mobile.

First an example of a method for establishing a call from a mobile calling party to a destination using a pre-answer service according to the state of the art will be described in more detail.

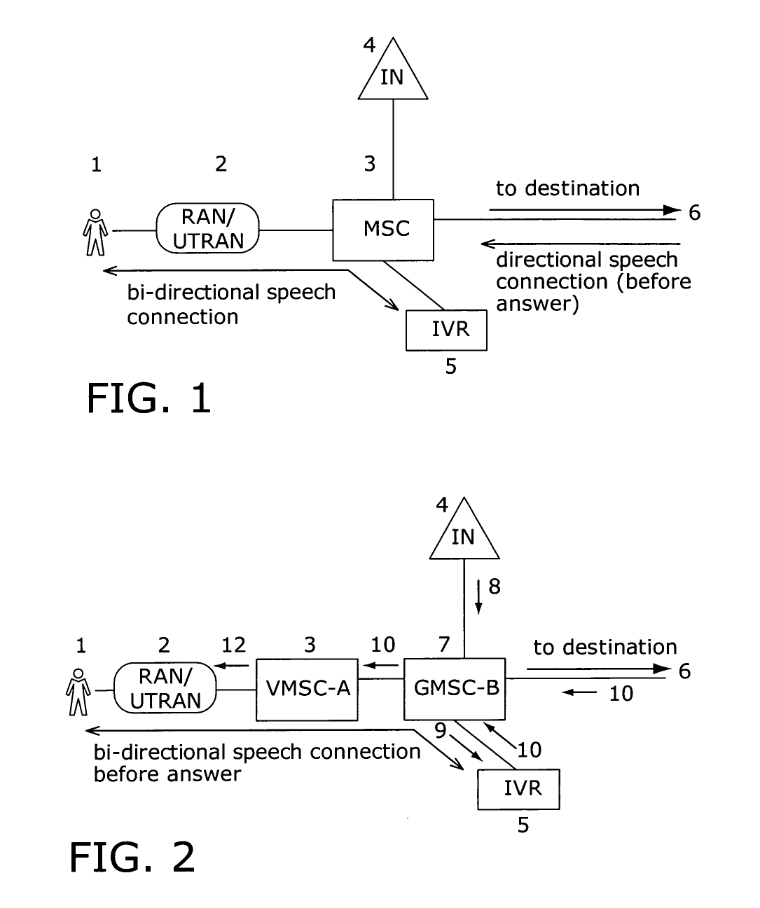

In FIG. 1, a calling party 1 is connected to a Mobile Switching Centre 3 (MSC) via a wireless connection or radio network (RAN/UTRAN) 2. An IN service 4, which can reside in a Service Control Point (SCP), can instruct upon invocation the MSC 3 to set up the call between the calling party 1 towards the MSC 3. The pre-answer service 5 is in this example performed by an Interactive Voice Response (IVR) system. Once user interaction is completed according to the pre-answer service 5, the IN service 4 may instruct the MSC 3 to disconnect the calling party 1 from the IVR 5 and to establish the call to the destination 6, for example another subscriber/called party or another service.

The speech path between calling party 1 and MSC 3 remains active. However, the speech path from MSC 3 in the direction of the destination 6 will be established only when the call is answered by the destination 6. Hence, when the call is answered, there will be a bidirectional speech path between calling party 1 and the destination 6 and at that moment, charging will start for the calling party 1 by MSC 3.

It should be appreciated by the person skilled in the art that the service 4 can only be performed without charging if the connection with the IVR 5 is established from the serving MSC 3 of the calling party 1 (Visited MSC of calling party, further referred to as VMSC-A). In the above-sketched architecture, the calling party 1 is connected to VMSC-A 3; an IN service 4 is invoked from VMSC-A 3. The IN service 4 can instruct VMSC-A 3 to connect the calling party to the IVR 5 without starting the charging process in VMSC-A 3.

If however the IN service 4 that is controlling the call and that connects the calling party 1 to the IVR 5 is invoked from another MSC than VMSC-A 3, then we have the following dilemma:
If the IN service 4 enables the calling party 1 to interact with an IVR 5 prior to call answer, then charging of the call starts in VMSC-A 3 as soon as the calling party 1 is connected to the IVR 5, since upon connection of the call to IVR 5 a connection confirmation message is sent to the calling party; this connection confirmation message has the effect that VMSC-A 3 starts charging calling party 1's account.
If the IN service 4 connects the calling party 1 to the IVR 5 prior to call connection confirmation, to prevent the VMSC-A 3 from charging the calling party, then no forward speech path from calling party 1 to IVR 5 is established, since a connection confirmation is necessary to establish the forward speech path. This has the effect that no interaction is possible between calling party 1 and IVR 5.

This dilemma is depicted in FIG. 2. The GMSC-B 7 in FIG. 2 receives an instruction 8 from the IN service 4 to establish a “through-connection” between the calling party 1 and the IVR 5, whereby the through-connection means a bi-directional speech path between calling party 1 and the IVR 5. Hereto, the GMSC 7 sets up a connection 9 to the IVR 5. When the IVR 5 is connected, the GMSC-B 7 sends a connection confirmation message 10 (ISUP ANM) to the calling party 1. The connection confirmation message 10 passes through i.e. is converted in the VMSC-A 3 which forwards it to the calling party 1, in the form of a DTAP Connect message 12. The effect of this connection confirmation message 10 passing through (and conversion in) VMSC-A 3 and to calling party 1 is as follows:
a speech path is opened between calling party 1 in the forward direction, towards the IVR 5 connected to GMSC-B 7;
VMSC-A 3 starts charging the calling party 1's account for the outgoing call, since VMSC-A 3 can't distinguish between a connection confirmation message 10 generated by the IVR connected to GMSC-B 7 and a connection confirmation message 11 generated by call connection confirmation from the destination 6.

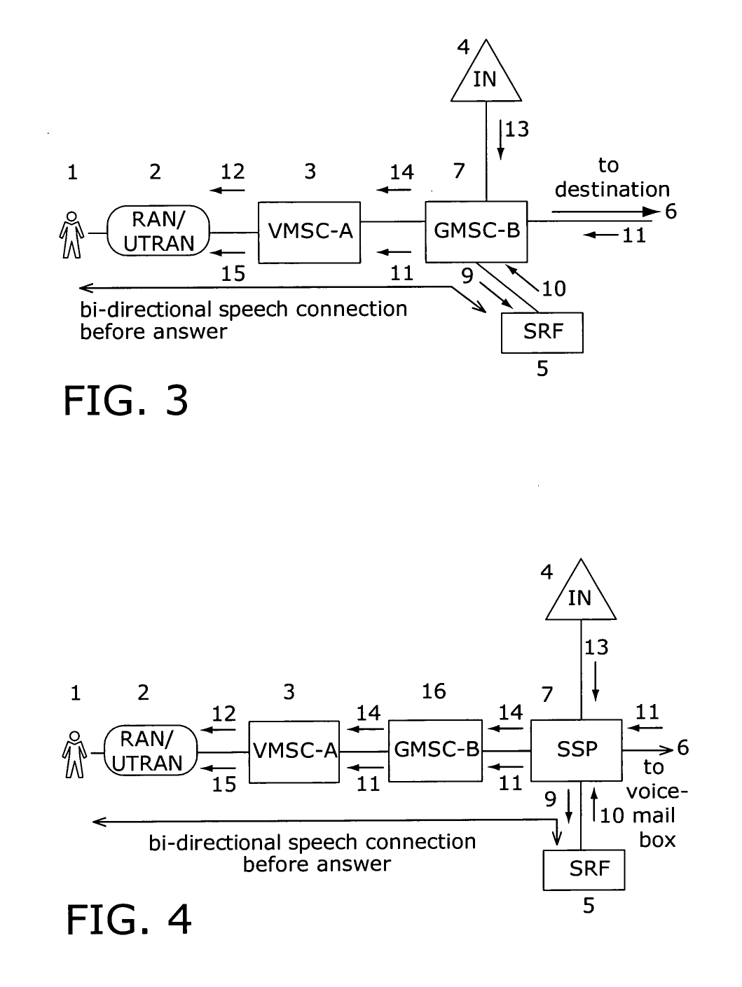

FIG. 3 shows an architecture according to an exemplary embodiment of the invention, comprising first and second switching nodes VMSC-A 3 and GMSC-B 7 respectively, wherein VMSC-A 3 is arranged for serving a calling party 1, including charging an account of calling party 1 when applicable, and GMSC-B 7 is arranged for invoking an IN service 4 and for connecting a call from the calling party 1 to a pre-answer service 5 under the control of IN service 4 and handling the connection to destination 6. The pre-answer service 5, can be implemented as a Specialized Resource Function (SRF), for example an IVR or any other service.

In this architecture, the IN service 4, invoked by GMSC-B 7, instructs GSMC-B 7 to connect the call to the pre-answer service 5 and further instructs GMSC-B 7 to wait for a connection confirmation message 10 from the pre-answer service 5 by means of a pre-answer instruction message 13.

The pre-answer instruction message 13 may be an INAP/CAP Connect To Resource (CTR) or Establish Temporary Connection (ETC) operation, whereby the CTR or ETC operation includes the Bothway Through Connection Indicator (BTCI). This parameter is used to indicate whether GMSC-B 7 will send an ISUP ANM message towards the VMSC-A 3 when the SRF 5 is connected.

According to the state of the art:
If BTCI would equal “bothwayPathRequired”, then the GMSC-B 7 would send a connection confirmation message (ISUP ANM) to VMSC-A 3 when the IVR 5 is connected, but that would start the charging for the calling party 1.
If BTCI would equal “bothwayPathNotRequired”, then the GMSC-B 7 would not send a connection confirmation message (ISUP ANM) to VMSC-A 3 when the IVR 5 is connected, but then no bidirectional speech path is established and calling party 1 could not perform user interaction with the IVR 5.

A formal abstract syntax notation of BTCI is:

| BothwayThroughConnectionIndicator ::= ENUMERATED { | |
|---|---|
| bothwayPathRequired | (0), |
| bothwayPathNotRequired | (1) |
| } | |

According to an embodiment of the invention a third value “bothwayPathPreAnswerRequired” for BTCI is now introduced, which will be sent by the IN service 4 to the GMSC-B 7 when sending the INAP/CAP CTR or ETC pre-answer instruction 13.

GMSC-B 7 is arranged according to the invention that if the BTCI in the pre-answer instruction message 13 has this value “bothwayPathPreAnswerRequired”, GMSC-B 7 sends an “establish pre-answer speech path” instruction 14 to VMSC-A 3 upon completion of the connection from the GMSC-B 7 to the pre-answer service 5, i.e. receipt of the connection confirmation message 10 from pre-answer service 5. This “establish pre-answer speech path” instruction 14 can be an adapted ISUP Call Progress message (CPG) or an adapted ISUP Facility message (FAC), including a designated parameter with a specific value, for example contained in an extension of the Generic Notification parameter.

VMSC-A 3 is in turn arranged to send a connection confirmation message 12, which may in fact be the DTAP Connect message of FIG. 1, to the calling party 1 upon receipt of the “establish pre-answer speech path” instruction 14 (ISUP CPG or ISUP FAC with designated parameter), wherewith the speech path connection is completed bidirectionally. But since VMSC-A 3 did not receive a connection confirmation message (ISUP ANM) from GMSC-B, VMSC-A 3 will not charge calling party's account.

When in the interaction with IVR 5 the calling party 1 opts to be connected to the destination 6, GMSC-B 7 will, under instruction from IN service 4, connect the calling party 1 to destination 6. When the destination 6 sends a connection confirmation message 11 (ISUP ANM) in backward direction, GMSC-B 7 applies normal handling, which entails the forwarding of the connection confirmation message 11 (ISUP ANM) towards VMSC-A 3. VMSC-A 3 will now start charging the calling party 1's account for the call as usual.

VMSC-A 3 is arranged however not to send a connection confirmation message 12 (DTAP Connect) to the calling party 1 upon receipt of the connection confirmation message 11 (ISUP ANM) from the destination 6 as described, since the calling party 1 has already received a connection confirmation message 12 (DTAP Connect). Instead VMSC-A is arranged to send a call progress message 15, (DTAP Progress).

From this example it must be understood by those skilled in the art that any number of intermediate switching nodes may be placed between VMSC-A 3 and GMSC-B 7, which will be described in the following examples.

FIG. 4 shows an architecture according to another embodiment of the invention. The switching node 7 connecting the calling party to the pre-answer service 5 and establishing the call destination 6 is now a Service Switching Point (SSP). In this example, GMSC-B 16 is now an intermediate switching node.

SSP 7 may, under instruction from IN service 4, connect the call to a destination 6, in this example a voice mail box. The IN service 4 may offer Call Completion functionality, such as e.g. Ericsson's Call Completion Application (CCA). IN service 4 will instruct SSP 7 to connect the call to IVR 5 for interaction with calling party 1 using the pre-answer instruction 13 according to the example in FIG. 3. Calling party 1 must not be charged for this interaction.

In the example, IN service 4 has an INAP/CAP connection with the SSP 7. IN service 4 uses the INAP/CAP connection for controlling the call, connecting to IVR 5, and connecting to voice mailbox 6 after completion of the interaction of the calling party 1 with IVR 5. The INAP/CAP operation 13 used for the connection of the call to the IVR 5 is Connect To Resource (CTR) or Establish Temporary Connection (ETC) as described.

The INAP/CAP CTR or ETC instruction 13 includes the BTCI parameter, which is given the value “bothwayPathPreAnswerRequired” value as described above, thereby instructing the SSP 7 to send an “establish pre-answer speech path” instruction 14 to VMSC-A 3 upon completion of the connection to IVR 5. This “establish pre-answer speech path” instruction 14 is the ISUP Call Progress message (CPG) or the ISUP Facility message (FAC) message with special parameter as described, whereupon receipt of which the VMSC-A 3 is arranged to send a connection confirmation message 12 to the calling party 1. This connection confirmation message 12 is the DTAP Connect message.

The calling party 1 now has a speech path open to the IVR 5. This speech path allows the calling party 1 to use Dual Tone Multi Frequency (DTMF) communication to signal to the IVR 5 and to interact with the IVR 5 menu. Charging of the account of calling party 1 by VMSC-A has not started since VMSC-A has not received a connection confirmation message.

When in the interaction with IVR 5 the calling party 1 opts to be connected to the voicemail box 6, SSP 7 will, under instruction from IN service 4, connect the calling party 1 to the voicemail box 6. When the voicemail box 6 sends a connection confirmation message 11 (ISUP ANM) in backward direction, the SSP 7 applies normal handling, which entails the forwarding of the connection confirmation message 11 (ISUP ANM) towards VMSC-A 3 via intermediate node 16. VMSC-A 3 will in turn, as instructed, start charging the calling party 1's account for the call. The VMSC-A 3 will however not send a connection confirmation message 12 (DTAP Connect) to the calling party 1 upon receipt of the connection confirmation message 11 (ISUP ANM) from the voicemail box 6 as described, since the calling party 1 has already received a connection confirmation message 12 (DTAP Connect). Instead VMSC-A 3 is arranged to send a call progress message 15 (DTAP Progress).

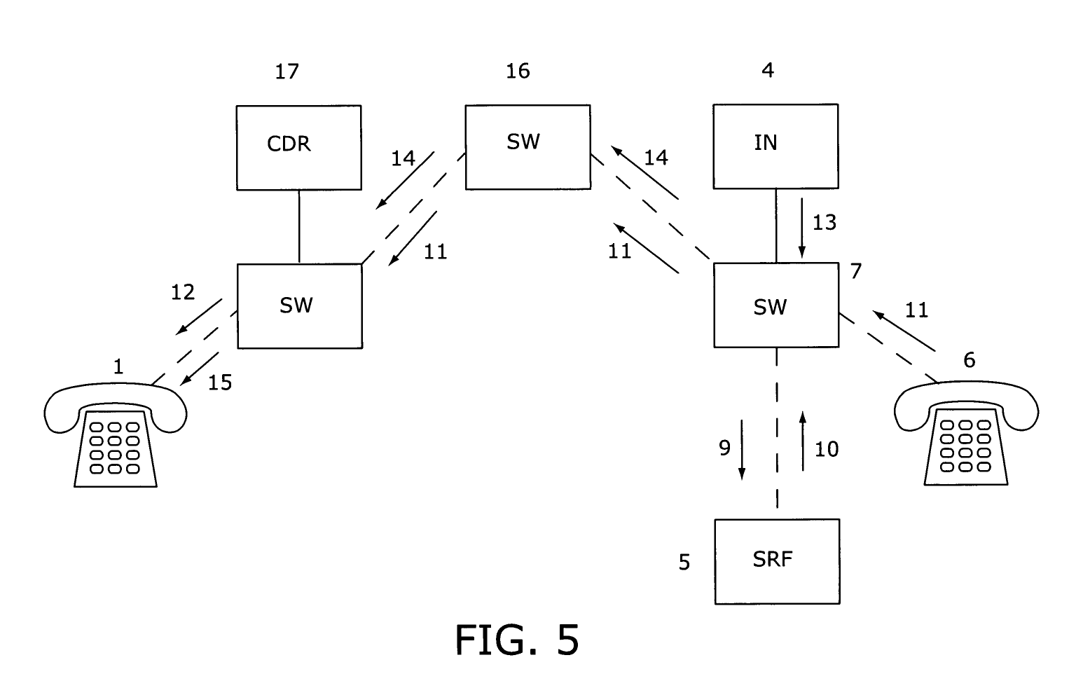

In another embodiment of the invention, as shown in FIG. 5, in a fixed telecommunication network or Plain Old Telephony Service (POTS), a calling party 1 is connected to a switch 3, which is also arranged for maintaining the calling party's account, for example by generating Call Detail Records (CDR) 17 which can be used for charging calling party's account and for billing, when a call is connected to a destination 6. Switching node 3 is for example a Local Exchange switch or a main switch.

Switch 7 (SW), arranged for connecting the calling party 1 to a pre-answer service 5 and subsequently establishing the call to destination 6, is now a telephone switch.

When a call is set up from the calling party to destination 6, the call may be intercepted by switch 7, whereby switch 7 invokes an IN service 4. This IN service 4 may offer Call Completion functionality. The IN service 4 instructs switch 7 to connect the call to a pre-answer service 5, which may be implemented as a Specialised Resource Function (SRF) 5 such as an IVR.

The IN service 4 uses an INAP connection for controlling the call, connecting to SRF 5, and connecting to destination 6 (if requested) etcetera. The INAP Connect To Resource (CTR) or Establish Temporary Connection (ETC) operation may be used for the connection of the call to the SRF 5 as described above.

The INAP CTR or ETC operation includes the parameter BTCI, which is given the value “bothwayPathPreAnswerRequired”, thereby instructing the switch 7 to send a “establish pre-answer speech path” instruction 14 to switch 3 upon connection confirmation of the call to SRF 5. SRF 5 thus sends an connection confirmation message (ISUP ANM) to switch 7.

Switch 7 is arranged to send an enhanced ISUP Call Progress message (CPG) 14 or an enhanced ISUP Facility message (FAC) 14 upon receipt of the connection confirmation message 10 (ISUP ANM) from SRF 5, whereupon switch 3 is arranged to send a connection confirmation message 12 (e.g. a Digital Subscriber Signaling System 1 (DSS1) Connect message) to the calling party 1.

The calling party 1 now has a speech path open to the SRF 5. This speech path allows the calling party 1 to use Dual Tone Multi Frequency (DTMF) communication to signal to the IVR 5 and to interact with a menu or interact with the SRF in any suitable way. Charging of the account of calling party 1 by switch 3 has not started since switch 3 did not receive a connection confirmation message (ISUP ANM).

When the pre-answer service 5 provided by SRF 5 is completed, e.g. by calling party 1 making a choice in a menu by pressing a button and thereby generating a DTMF signal upon which IN service 4 responds by instructing switch 7 to disconnect the call from the SRF 5 and to connect the call to destination 6. When the call establishment to the destination 6 is completed, the destination 6 sends a connection confirmation message 11 (ISUP ANM) in backward direction. Switch 7 applies normal handling, which entails the forwarding of the connection confirmation message 11 (ISUP ANM) towards switch 3. Switch 3 will now in turn also apply normal handling by the starting of the charging the calling party 1 for the call. Switch 3 will however not send a connection confirmation message 12 (DSS1 Connect) to the calling party 1 upon receipt of the connection confirmation message 11 (ISUP ANM) from the destination 6 as described, since the calling party already received a connection confirmation message (DSS1 Connect). Instead a call progress (DSS1 Progress) message 17 will be sent.

From this example it must be understood by those skilled in the art that any number of intermediate switching nodes may be placed between switch 3 and switch 7, which will be described in the following examples.

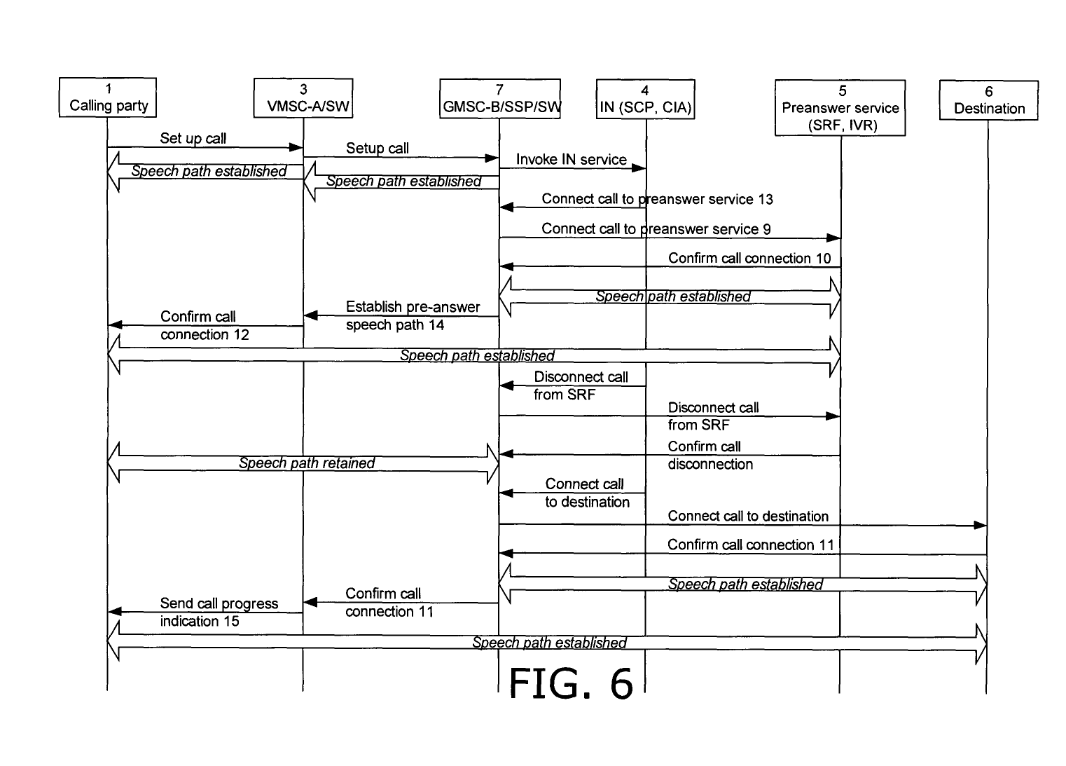

FIG. 6 shows a sequence diagram relating to the exemplary embodiment of FIGS. 3, 4 and 5 according to the invention.

The calling party 1 sets up a call to a destination via VMSC-A/Switch 3 (backward speech path is established), GMSC-B/SSP/Switch 7 (backward speech path is established), whereby the call is intercepted by GMSC-B/SSP/Switch 7 which invokes IN service 4. IN service 4 sends a pre-answer instruction 13 to GMSC-B/SSP/Switch 7 (INAP/CAP CTR or ETC, with BTCI set to “bothwayPathPreAnswerRequired”). GMSC-B/SSP/Switch 7 connects the call to pre-answer service 5 (Specialised Resource Function (SRF)).

Pre-answer service 5 confirms call connection (ISUP ANM), thus a bidirectional speech path is established between GMSC-B/SSP/Switch and pre-answer service 5. GMSC-B/SSP/Switch 7 sends “establish pre-answer speech path” instruction 14 (ISUP CPG or FAC message with special parameter) to VMSC-A/Switch 3. VMSC-A/Switch 3 sends confirm call connection message (DTAP Connect/DSS1 Connect) 12 to calling party 1. Now the speech path between calling party 1 and pre-answer service 5 is complete and bidirectional. The pre-answer service 5 will be performed and completed.

Consequently IN service 4 instructs GMSC-B/SSP/Switch 7 to disconnect the call from the pre-answer service 5 and connect the call to destination 6. Destination 6 confirms call connection 11 (ISUP ANM), and bidirectional speech path is established between GMSC-B/SSP/Switch 7 and destination 6. The connection confirmation message 11 is forwarded by GMSC-B/SSP/Switch 7 to VMSC-A/Switch 3. VMSC-A/Switch 3 sends a call progress indication message (DTAP Progress or DSS1 Progress) 15 to calling party and starts charging calling party 1's account. Now the bidirectional speech path from calling party 1 to destination 6 is complete.

In a further embodiment according to the invention, an operator may want to limit the usage of the pre-answer through connection to subscribers that are served by an MSC in the home network, i.e. Home Public Land Mobile Network (HPLMN). Reason is that other operator(s) may not want to provide the pre-answer through connection before connection confirmation, since the charging does not start until connection confirmation. Also, other network(s) may not support the capability in the MSC/GSM Service Switching Function (gsmSSF) to provide the through connection before connection confirmation.

Hence, to ensure that this mechanism is used in the HPLMN only, the following may be considered in a further embodiment according to the invention:
An IN service 4 using this method, e.g. a Personal Greeting Service (PGS), determines the location of the calling party 1; this is common practice in PGS and in some other IN services. The IN service may detect whether the served subscriber resides in the HPLMN or not, by for example inspecting the Location number that may be transported from the VMSC serving the calling subscriber to the invoking MSC and that is reported from this invoking MSC to the IN service. PGS uses the pre-answer through connection only when the calling subscriber resides in the operator's HPLMN. Otherwise, PGS uses “normal” through connection, which has the effect that the calling party will be charged for the through connection, as is the case in the art.
A GMSC 7 shall not send the “establish pre-answer speech path” message 14 containing the pre-answer through connect instruction across HPLMN boundary. If the preceding exchange, to which the “establish pre-answer speech path” message 14 shall be sent, resides in another network, then the “establish pre-answer speech path” message 14 (ISUP CPG or ISUP FAC with special parameter) containing the pre-answer through connect instruction, shall be converted to a connection confirmation message (ISUP ANM). A subsequent connection confirmation message (ISUP ANM) received by GMSC-B 7 will be converted to a call progress indication message (ISUP CPG).

Other methods can also be considered.

The invention may be used for the following scenarios:
Call Completion Application (CCA): the calling party 1 should be able to interact with a menu as pre-answer service 5, before being charged. When the calling party 1 opts to be connected to a voice mail box as destination 6, then charging starts when the calling party 1 is connected to the voicemail box.
Personal Greeting Service (PGS): the calling party 1 is connected to a personal greeting as pre-answer service 5 during the alerting phase of the call. Whilst the calling party 1 is listening to this greeting, e.g. a music clip, the calling party may interact with the content system that the calling party 1 is connected to, i.e. the system that is playing the music clip. Interaction with the content system allows for the following (list is not exhaustive):
Calling party 1 may for example press the “*”-button to suppress the personal greeting and revert to the regular ring-back tone; the calling party 1 may use DTMF keys to indicate calling party 1 wants to purchase the music clip;
Premium rate call: when the calling party 1 performs a premium rate call, calling party 1 may interact with a menu to indicate the type of information that is needed. When the selection is made, the calling party 1 will be connected to a destination 6 comprising a content system/agent/call centre 6 etc. that will provide the requested information/content etc. Charging starts when the content system/agent etc. answers.
Video call message: if the network wants to play a pre-answer video message to a calling party 1, then a bi-directional speech path is required with this calling subscriber. Reason is that video codec negotiation is done in-band, i.e. using the speech path with the calling party 1. The term “speech path” shall in this case be interpreted as “media connection”. Both speech call and video call use circuit switched media connection.
If video call establishment from a calling party 1 fails, e.g. due to lack of capabilities of the destination or lack of capabilities of the network currently serving the destination, then the network may use the pre-answer voice connection method to facilitate the playing of a video announcement to the calling party 1, without charging the calling party's account.

The invention may furthermore be used for video mail box as destination 6. A voicemail box may have a toll-free welcome message as pre-answer service, with a duration of typically a few seconds. After the playing the welcome message, the ISUP connection confirmation message is generated and charging of the calling party account starts. To facilitate a toll-free welcome video message, the pre-answer speech path method, as described in the present invention, may be used.

It must be understood that the description of the embodiments is given by way of example only and that variations and modifications are possible to these embodiments without departing from the scope of the invention as defined by the claims attached hereunder.

1-15. (canceled)

16. A method for establishing a call from a calling party to a destination using a pre-answer service in a telecommunication network, the telecommunication network comprising a first switching node and a second switching node, the first and second switching nodes communicatively connected, the calling party communicatively connected to the first switching node, the destination communicatively connected to the second switching node, and said method comprising the steps of:
setting up a call between the calling party and the second switching node;
invoking an IN service associated with the pre-answer service;
connecting the call to the pre-answer service;
charging an account of the calling party by the first switching node upon receiving a connection confirmation message relating to the call;
completing the pre-answer service;
disconnecting the call from the pre-answer service upon completion of the pre-answer service;
connecting the call to the destination;
sending a pre-answer instruction to the second switching node upon invoking the IN service, whereby the step of connecting the call to the pre-answer service is performed upon receipt of the pre-answer instruction;
sending an establish pre-answer speech path instruction to the first switching node upon connection confirmation from the pre-answer service; and
sending a connection confirmation message to the calling party by the first switching node upon receipt of the establish pre-answer speech path instruction, whereby the step of charging the account of the calling party is performed upon completing the step of connecting the call to the destination.

17. The method of claim 16, further comprising:
sending a call progress indication message by the first switching node to the calling party upon completing the step of connecting the call to the destination.

18. The method of claim 16, further comprising:
establishing the presence of the calling party in a home public land mobile network or home public switched telephone network; and
sending a call completion message upon completion of the connection to the pre-answer service if the calling party is not in the Home public land mobile network or Public Switched Telephone Network (PSTN).

19. An IN service entity for providing an IN service, said IN service entity connected to a first switching node, and wherein the IN service is invoked from the first switching node upon interception of a call by the first switching node, and wherein the IN service entity is configured to:
send a pre-answer instruction to a second switching node, said pre-answer instruction causing the second switching node to connect the call to a pre-answer service entity, and further causing the first switching node to send an establish pre-answer speech path instruction to the second switching node upon connection confirmation to the pre-answer service;
disconnect the call from the pre-answer service upon completion of the pre-answer service by the pre-answer service entity; and
connect the call to the destination.

20. The IN service entity of claim 19, wherein the pre-answer instruction is an INAP/CAP Connect To Resource (CTR) or Establish Temporary Connection (ETC) operation.

21. The IN service entity of claim 20, wherein the INAP/CAP Connect To Resource (CTR) or Establish Temporary Connection (ETC) operation comprises a Bothway Through Connection Indicator (BTCI) having a value “bothwayPathPreAnswerRequired”.

22. A switching node for serving a calling party, said switching node communicatively connected to a second switching node and the calling party, and configured to charge an account of the calling party for a call from the calling party to a destination, upon receipt of a connection confirmation message relating to the call, and wherein said switching node is further configured to:
send a connection confirmation message to the calling party upon receipt of an establish pre-answer speech path instruction from the second switching node.

23. The switching node of claim 22, wherein said switching node is further configured to send a call progress indication message to the calling party upon receipt of the connection confirmation message relating to the call.

24. The switching node of claim 22, wherein the establish pre-answer speech path instruction comprises an ISUP Call Progress (CPG) message or an ISUP Facility (FAC) message with an argument indicating the Switching node to send a connection confirmation message to the calling party.

25. The switching node of claim 22, wherein the call progress indication message comprises a DTAP Progress message or a DSS1 Progress message.

26. A switching node for providing a pre-answer service, said switching node communicatively connected to an IN service entity, a further switching node, a pre-answer service entity and a destination, and wherein said switching node is configured to invoke the IN service entity and connect a call from the further switching node to the pre-answer service entity, and connect a call from the further switching node to the destination, and wherein said switching node is further configured to:
receive a pre-answer instruction from the invoked IN service entity;
connect the call to the pre-answer service entity upon receipt of the pre-answer instruction; and
send an establish pre-answer speech path instruction to the further switching node upon receiving connection confirmation from the pre-answer service.

27. The switching node of claim 26, wherein the pre-answer instruction comprises an INAP/CAP Connect To Resource (CTR) or Establish Temporary Connection (ETC) operation.

28. The switching node of claim 27, wherein the INAP/CAP Connect To Resource (CTR) or Establish Temporary Connection (ETC) operation comprises a Bothway Through Connection Indicator (BTCI) having a value “bothwayPathPreAnswerRequired”.

29. The switching node of claim 26, wherein the establish pre-answer speech path instruction comprises an ISUP Call Progress (CPG) message or an ISUP Facility (FAC) message with an argument indicating the further switching node to send a connection confirmation message to the calling party.
